(19) United States
(12) Patent Application Publication
(10) Pub. No.: US 2014/0037815 A1
(43) Pub. Date: Feb. 6, 2014

(54) Roti and process for making same

(71) Applicants: Diane King, Houston, TX (US); Leslyn Brown, Decatur, GA (US)

(72) Inventors: Diane King, Houston, TX (US); Leslyn Brown, Decatur, GA (US)

(21) Appl. No.: 13/507,833

(22) Filed: Aug. 2, 2012

(51) Int. Cl. A21D 6/00

(52) U.S. Cl. CPC A21D 6/00
USPC 426/551; 426/502

(57) ABSTRACT

The process of making Roti includes mixing predetermined amounts of flour baking soda and water so that a soft elastic dough is formed. The dough is then formed into a first round disk of a predetermined diameter. The first round disk of dough is then rubbed with a predetermined amount of oil, and reconfigured so that a second round disk of dough is formed. The second disk of dough is oiled then baked on each side thereof forming an untexturized Roti 10. The hot untexturized Roti is then placed into a texturizing apparatus 12. The untexturized Roti 10 is texturized by manipulating the apparatus so that a predetermined motion is implemented. This allows Roti 22 to form having a flaky surface 24. The Roti 22 is then removed from the texturizing apparatus 12 and placed in a pre-prepared container.

### TECHNICAL FIELD

This invention relates to bread products and more particularity to breads which in themselves have a unique taste. Such breads can be enjoyable when they can be used as a carrier for foods such as meats, fish and vegetables while also being enjoyable when eaten with different meals because of the unique taste of the bread. This kind of bread is desirable. The most difficult characteristic to achieve when preparing such a bread is the unique taste. Because of the desire to have the unique taste many breads have become somewhat extravagant mixtures of many different ingredients and/or requires complex processes to make. However rather than this approach to creating a bread having a unique taste one may also create the unique taste by varying the texture of the bread. A bread having a flaky textured surface can provide that unique taste. Accordingly there becomes a need to provide a bread which will have a flaky textured surface thereby creating a unique taste while also allowing the bread to be desirable when used as a carrier for all kinds of foods and/or as an accompaniment to different meals.

### BACKGROUND ARTS

Attempts have been made to provide breads which have a unique taste. One such bread is disclosed in U.S. Pat. No. 5,510,126. This patent discloses a method for improving the quality and taste of wheat flour tortillas. In general flour tortilla formulations contain four major ingredients: flour, water salt and shortening/oil. However, other ingredients such as leavening agents, yeast, sugar emulsifiers, preservatives, acidulates and gums are commonly used to further improve the quality and taste. Additionally in this bread, a fermentation flavor is produced by using up to 1% of active dry yeast or up to 3% of regular compressed yeast. This also provides an improvement of the quality and taste of wheat flour tortillas because of the yeast derivative in the tortilla dough.

Another bread is disclosed in U.S. Pat. No. 4,020,184. This patent discloses a pizza ersatz in the form of a bread and a process for making the same. The dough for this bread is prepared using a tomato based formula providing pizza flavor ingredients for homogeneous distribution throughout a soft textured baked bread loaf. A charge of stabilized flavor intensifier is inserted into a preformed incision in the dough surface for limited migration during baking. The baking procedure also includes the introduction of a flowable cheese composition having a viscous consistency for containment within a confined area on the bread surface. This provides for a unique taste and improved quality.

These breads achieve varied and unique taste by utilizing somewhat different processes and/or mixtures of different ingredients. They do not however achieve a unique taste by varying the texture of the bread. Accordingly a bread having a unique texture specifically a flaky textured surface is desirable so that the unique taste which enhances the flavor of the bread is provided.

### DISCLOSURE OF THE INVENTION

This invention relates to an improved bread which has a flaky texturized quality. The bread disclosed in this invention is commonly known as Roti. The Roti in accordance with the invention is provided in predetermined weight quantities of a mixture of (1) flour (2) baking powder (3) water and (4) oil.

The process of making the bread of this invention includes mixing predetermined amounts of flour baking soda and water so that a soft elastic dough is formed. Once the dough is formed it is rolled into a round ball and allowed to sit until it rises. The round ball is then flatten into a round disk of a predetermined diameter. The round disk of dough is then rubbed with a predetermined amount of oil. The oiled disk of dough is then cut and rolled into a predetermined cone-cup shaped configuration which is then reconfigured by pushing the dough inward at the uppermost point of the cone. After sitting a second predetermined time the reconfigured cone-cup shaped of dough is then pressed into a second round disk and a second predetermined amount of oil is applied thereto. The second disk of dough is then heated at a predetermined temperature and allowed to bake on each side thereof. Once baking is complete an untexturized Roti is formed. The untexturized Roti while still hot is then placed into a texturizing apparatus. While in the texturizing apparatus the untexturized Roti is put through a predetermined motion which is implemented by manipulating the apparatus in a predetermined manner. This allows the surface of the Roti to develop the desired flaky texture. The Roti is then removed from the texturizing apparatus and placed in a pre-prepared wrapper.

### BRIEF DESCRIPTION OF THE DRAWING

The details of the invention will be described in connection with the accompanying drawing in which:

FIG. 1 is a perspective view illustrating the untexturized Roti in accordance with the principles of the invention.

FIG. 2 is a front perspective view illustrating a Roti texturizing apparatus used in accordance with the principles of the invention.

FIG. 3 is an open front perspective view illustrating a Roti texturizing apparatus used in accordance with the principles of the invention.

FIG. 4 is a perspective view illustrating untexturized Roti folded and placed in the Roti texturizing apparatus in accordance with the principles of the invention.

FIG. 5 is a perspective view illustrating the texturized Roti in a folded configuration after being removed from the texturizing apparatus in accordance with the principles of the invention.

### BEST MODE FOR CARRYING OUT THE INVENTION

In accordance with the preferred embodiment of the invention a novel bread having a flaky texture is provided. The bread in accordance with the present invention which is known as Roti contains on a weight basis 38.7% all purpose flour, 0.8% baking powder, 38.7% warm water and 21.8% oil.

A typical process for preparation of the Roti begins with combining on a weight basis 37.7% flour with 0.8% baking soda. Once this is done an aperture is formed in the center of the flour baking soda combination and on a weight basis 38.7% warm water is poured into the aperture. This combination of flour, baking soda and water is then mixed together to form a dough. This dough is then kneaded lightly for five (5) to ten (10) minutes until the dough is soft and elastic.

This elastic dough is then formed into a round elastic ball of dough. The ball of dough is then allowed to sit for five minutes thereby allowing it to rise. During this time the elastic ball of dough may be covered, for example, with a towel or paper towel.

After this is done the round elastic ball of dough is then pressed into a first round disk of about seven to eight inches in diameter. This can be accomplished, for example, with a standard rolling pin. Oil on a weight basis of 10.4% is then lightly rubbed or brushed on the elastic disk of dough. This can be done with a pastry brush or the back of a tablespoon.

The elastic disk of dough is then cut from the center thereof to an outermost edge. Then the disk of dough is rolled around until it is formed into a cone-cup shape. The loose end of the cone-cup shape of dough is then tucked into the bottom thereof so that layers of the dough are not visible. The cone-cup shape of dough is reconfigured by turning it up and pushing it in at the top of the point of the cone. The dough is again covered and allowed to sit for another ten minutes. Next the reconfigured cone-cup shaped of dough is prepared with flour and pressed into a second round disk of dough by rolling it out as it's being turned at 90 degree angles. This allows opposite sides of the dough to be rolled until the dough is round. The dough is prepared with the flour by, for example, spreading 1% by weight of flour on a counter top and then rolling it as described.

The second round disk of dough is then heated at a predetermined temperature so that baking can occur. As each side of the dough is being baked, air bubbles are created. Once this occurs 10.4% by weight of oil is applied thereto as the disk of dough is being turned over on each side thereof. The second disk of dough should continue to bake for one minute while turning constantly. The heat necessary to bake the second disk of dough may be accomplished, for example, with an electric griddle set at medium temperature which has been pre-oiled with a small amount of oil to keep the second disk of dough from sticking to the griddle during the baking process.

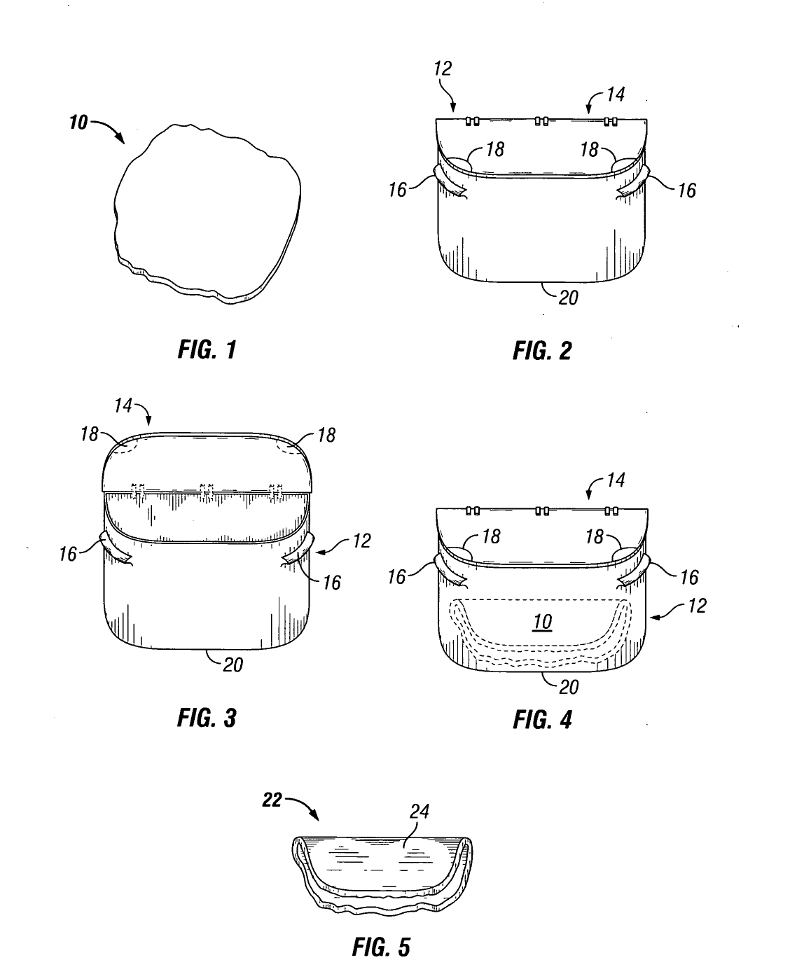

As illustrated in FIG. 1, once baking is completed an untexturized piece of Roti, generally designated, by the numeral, 10 is formed. While still hot the untexturized Roti 10 is folded (FIG. 2) and placed into a Roti texturizing apparatus, generally designated, by the numeral, 12 (FIGS. 2-4). The texturizing apparatus 12 is picked up by a user (not shown) by grabbing gripping members 16 and 18 with a user's fingers and thumbs, respectively. The apparatus 12 is then shaken vigorously ten to twelve times, causing the untexturized Roti 10 to alternately hit the top 14 and bottom 20 of the apparatus. Because the untexturized Roti 10 is shaken while still hot the desired texturization occurs. Accordingly, a texturized Roti, generally designated, by he numeral, 22 is formed having a flaky surface 24. The texturized Roti 22 is then removed from the texturizing apparatus 12, and placed into a desired wrapper until it is consumed.

The Roti 22 can then be served, hot or room temperature with your favorite food or can be used as a carrier and filled with any kind of food.

The invention has been shown and described in what is considered to be the most practical and preferred embodiments. However, it should be recognized that changes may be made by those skilled in the art without departing from the spirit and scope of the invention.

What is claimed:

1. A process for making Roti consisting of:
blending together a predetermined amount of flour and baking soda;
forming an aperture in the center of the blended flour and baking soda;
adding a predetermined amount of warm water to the aperture of the blended flour and baking soda;
mixing the blended flour and baking soda with the water until a dough is formed;
kneading the dough for a predetermined time until the dough is soft and elastic;
forming the elastic dough into a round ball of dough;
covering the round ball of dough and allowing the dough to sit for a predetermined time;
pressing the round ball of dough into a first round disk of dough having a predetermined diameter;
rubbing a predetermined amount of oil onto the first round disk of dough;
cutting the first round disk of dough from the center thereof to an outermost edge thereof so that the disk of dough can be rolled into a cone-cup shape configuration;
reconfiguring the cone-cup shaped of dough by turning the cone-cup up and pressing the dough in at the uppermost point of the cone;
allowing the reconfigured cone-cup shaped of dough to set for a predetermined time;
spreading a predetermined amount of flour on the reconfigured cone-cup shaped of dough;
pressing the reconfigured cone shaped of dough into a second round disk of dough;
heating each side of the second round disk of dough at a predetermined temperature for a predetermined time while applying a second predetermined amount of oil thereto so that untexturized Roti is formed;
folding the hot untexturized Roti into a predetermined configuration and placing the untexturized Roti into an apparatus for facilitating the texturizing of the Roti;
moving the texturizing apparatus so that a predetermined motion is implemented which allows the untexturized Roti to develop a flaky surface thereby forming texturized Roti; and
removing the texturized Roti from the texturizing apparatus.

2. A process as defined in claim 1 wherein the predetermined amounts of flour and baking soda that are blended together includes
thirty eight and eight tenths percent by weight of flour and eight tenths percent by weight of baking soda.

3. A process as defined in claim 2 wherein the predetermined amount of water added to the aperture in the blended flour and baking soda includes thirty eight and eight tenths percent by weight of warm water.

4. A process as defined in claim 3 wherein the predetermined time for kneading the dough is ten minutes.

5. A process as defined in claim 4 wherein the round ball of dough is covered and allowed to sit for ten minutes so that the dough can rise.

6. A process as defined in claim 5 wherein the first round disk of dough has a diameter of eight inches.

7. A process as defined in claim 6 wherein the predetermined amount of oil rubbed onto the first round disk of dough includes ten and four tenths percent by weight of oil.

8. A process as defined in claim 7 wherein the predetermined time the reconfigured cone-cup shaped of dough is allowed to sit is ten minutes.

9. A process as defined in claim 8 wherein the predetermined amount of flour spread on the reconfigured cone-cup shaped dough includes one percent by weight of flour.

10. A process as defined in claim 9 wherein the predetermined time the second round disk of dough is heated is one minute.

11. A process as defined in claim 10 wherein the second predetermined amount of oil applied to the second round disk of dough is ten and four tenths percent by weight of oil.

12. Roti made by the process of claim 1.

13. Roti made by the process of claim 2.

14. Roti made by the process of claim 3.

15. Roti made by the process of claim 4.

16. Roti made by the process of claim 5.

17. Roti made by the process of claim 6.

18. Roti made by the process of claim 7.

19. Roti made by the process of claim 8.

20. Roti made by the process of claim 9.

21. Roti made by the process of claim 10.

22. Roti made by the process of claim 11.
